(19) United States
(12) Patent Application Publication
(10) Pub. No.: US 2026/0219474 A1
(43) Pub. Date: Jul. 30, 2026

(54) OPTICAL APPARATUS

(71) Applicant: CANON KABUSHIKI KAISHA, Tokyo (JP)

(72) Inventor: KENTA TAKAI, Kanagawa (JP)

(21) Appl. No.: 19/438,283

(22) Filed: Dec. 31, 2025

(30) Foreign Application Priority Data
Jan. 29, 2025 (JP) 2025-012604

(51) Int. Cl. G02B 7/16

(52) U.S. Cl. CPC G02B 7/16

(57) ABSTRACT

An optical apparatus includes an operation member, a spring member configured to bias the operation member, a fixing member including a limiter configured to restrict a moving range of the operation member, and an elastic member held by the operation member. The elastic member includes an engagement portion that is engaged with an arm portion of the spring member, and a contact portion that contacts the limiter. In a case where the contact portion is in contact with the limiter, the spring member biases the elastic member in a moving direction of the operation member and in a direction orthogonal to the moving direction.

### BACKGROUND

### Field of the Technology

The present disclosure relates to an optical apparatus having an operation member.

### Description of the Related Art

Optical apparatuses may achieve quiet operations of their control elements in order to capture a high-quality moving image. Japanese Patent No. 6016618 discusses a structure in which an elastic member is always in contact with a spring member for returning a control element to a neutral position. Japanese Patent Application Laid-Open No. 2011-203585 discusses a structure in which an elastic member comes into contact with a limiting member that restricts the moving range of the control element before the limiting member collides with the control element.

### SUMMARY

An aspect of the present disclosure provides an optical apparatus that includes an operation member, a spring member configured to bias the operation member, a fixing member including a limiter configured to restrict a moving range of the operation member, and an elastic member held by the operation member. The elastic member includes an engagement portion that is engaged with an arm portion of the spring member, and a contact portion that contacts the limiter. In a case where the contact portion is in contact with the limiter, the spring member biases the elastic member in a moving direction of the operation member and in a direction orthogonal to the moving direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views of an interchangeable lens and a digital camera according to one embodiment of the disclosure.

FIG. 2 is a block diagram illustrating the configurations of the interchangeable lens and the digital camera.

FIG. 3 is a sectional view of the interchangeable lens and digital camera in a retracted state.

FIG. 4 is a sectional view of the interchangeable lens and digital camera in an extended state.

FIG. 5 is an exploded perspective view of the interchangeable lens according to a first embodiment.

FIG. 6 is a side sectional view of the interchangeable lens according to the first embodiment.

FIG. 7 is a front sectional view of the interchangeable lens according to the first embodiment.

FIGS. 8A and 8B explain the interchangeable lens according to the first embodiment.

FIG. 9 is a detailed sectional view of the interchangeable lens according to the first embodiment.

FIG. 10 is a detailed sectional view of the interchangeable lens according to a second embodiment.

### DESCRIPTION OF THE EMBODIMENTS

Referring to the accompanying drawings, a detailed description will be given of embodiments according to the disclosure. Corresponding elements in respective figures will be designated by the same reference numerals, and a duplicate description thereof is incorporated by reference without being repeated, for conciseness.

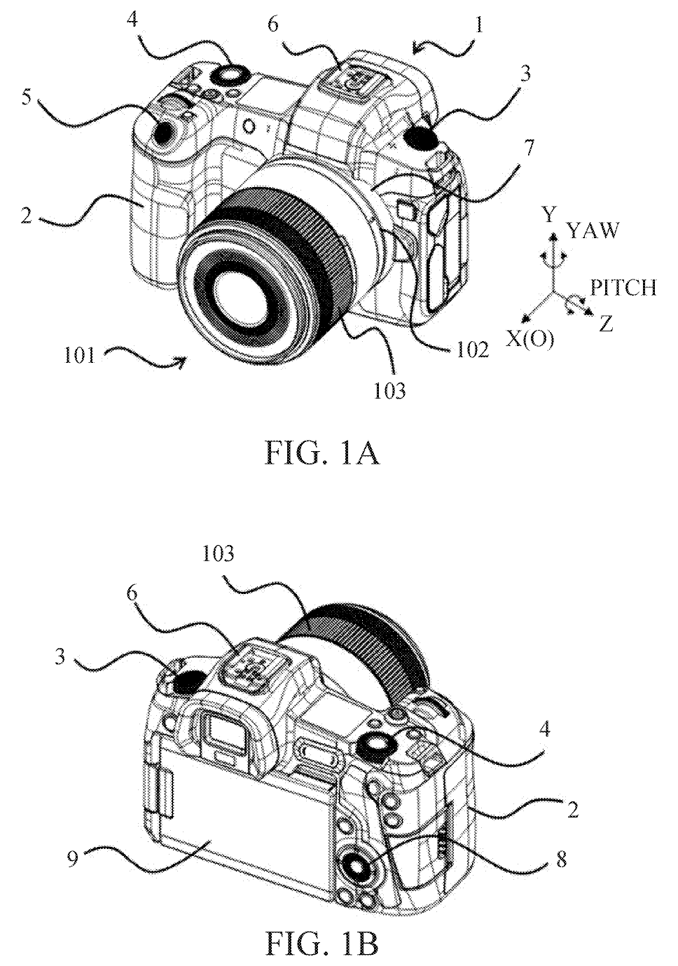

FIGS. 1A and 1B are external views of an interchangeable lens (optical apparatus) 101 and a digital camera (referred to as the camera body hereinafter) 1 to which the interchangeable lens 101 is detachably attached, according to one embodiment of the disclosure. FIGS. 1A and 1B illustrate front and rear views, respectively. As illustrated in FIG. 1A, an optical axis direction along which the optical axis of the imaging optical system housed in the interchangeable lens 101 extends is an X-axis direction, and directions orthogonal to the X-axis direction are a Z-axis direction (horizontal direction) and/or a Y-axis direction (vertical direction). Hereinafter, the Z-axis direction and the Y-axis direction are collectively referred to as the Z/Y-axis direction. A rotation direction around the Z-axis is a pitch direction, and a rotation direction around the Y-axis is a yaw direction. The pitch direction and the yaw direction (collectively referred to as the pitch/yaw direction hereinafter) are rotation directions around two axes, the Z-axis and the Y-axis, which are orthogonal to each other.

In this embodiment, an interchangeable lens is an example of an optical apparatus, but the disclosure is also applicable to other optical apparatuses such as lens integrated type cameras.

Provided on the left side (right side when viewed from the rear) of the camera body 1 viewed from the front (object side) is a grip portion 2 for the user to hold the camera body 1 with his hand. A power operation unit 3 is located on the top surface of the camera body 1. When the user operates the power operation unit 3 to turn the camera on while the camera body 1 is in the power-off state, the camera body 1 enters the power-on state for imaging. In a case where the user operates the power operation unit 3 to turn the camera off while the camera body 1 is in the power-on state, the camera body 1 enters the power-off state.

A mode dial 4, a release button 5, and an accessory shoe 6 are provided on the top surface of the camera body 1. The user can switch the imaging mode by rotating the mode dial 4. The imaging modes include a manual still image capturing mode in which the user can arbitrarily set an imaging condition such as a shutter speed and an aperture value (F-number), an automatic still image capturing mode that automatically obtains a proper exposure amount, and a moving image capturing mode for capturing a moving image. By half-pressing the release button 5, the user can instruct the camera to perform an imaging preparation operation such as autofocus (AF) and auto-exposure (AE) controls. By fully pressing the release button 5, the user can instruct the camera to capture an image. Accessories such as an external flash and an external viewfinder (EVF) can be attachable to and detachable from the accessory shoe 6. An image sensor is provided inside the camera body 1 that photoelectrically converts (images) the object image formed by the imaging optical system within the interchangeable lens 101.

The interchangeable lens 101 is mechanically and electrically connected to a camera mount 7 provided on the camera body 1 via a lens mount 102. As discussed above, the interchangeable lens 101 houses an imaging optical system that forms an object image using light from the object. A zoom operation ring 103, which can be rotated around the optical axis by user operation, is provided on the outer circumference of the interchangeable lens 101. The outer circumference of the zoom operation ring 103 is knurled to prevent the user's hand from slipping during operation. In a case where the zoom operation ring 103 is rotated by the user, the zoom unit constituting the imaging optical system moves to a predetermined optical position corresponding to the angle of the zoom operation ring 103. Thus, the user can capture an image at a desired angle of view.

As illustrated in FIG. 1B, the back of the camera body 1 is provided with a rear operation unit 8 and a display unit 9. The rear operation unit 8 includes a plurality of buttons and dials assigned to various functions. When the camera body 1 is powered on and a still or moving image capturing mode is set, the display unit 9 displays a live-view image of the object image being captured by the image sensor. The display unit 9 displays an imaging parameter indicating an imaging condition such as a shutter speed and an aperture value, and the user can change a setting value of the imaging parameter by operating the rear operation unit 8 while viewing the display. The rear operation unit 8 includes a playback button for instructing the playback of recorded images, and when the user operates the playback button, a captured image is displayed on the display unit 9.

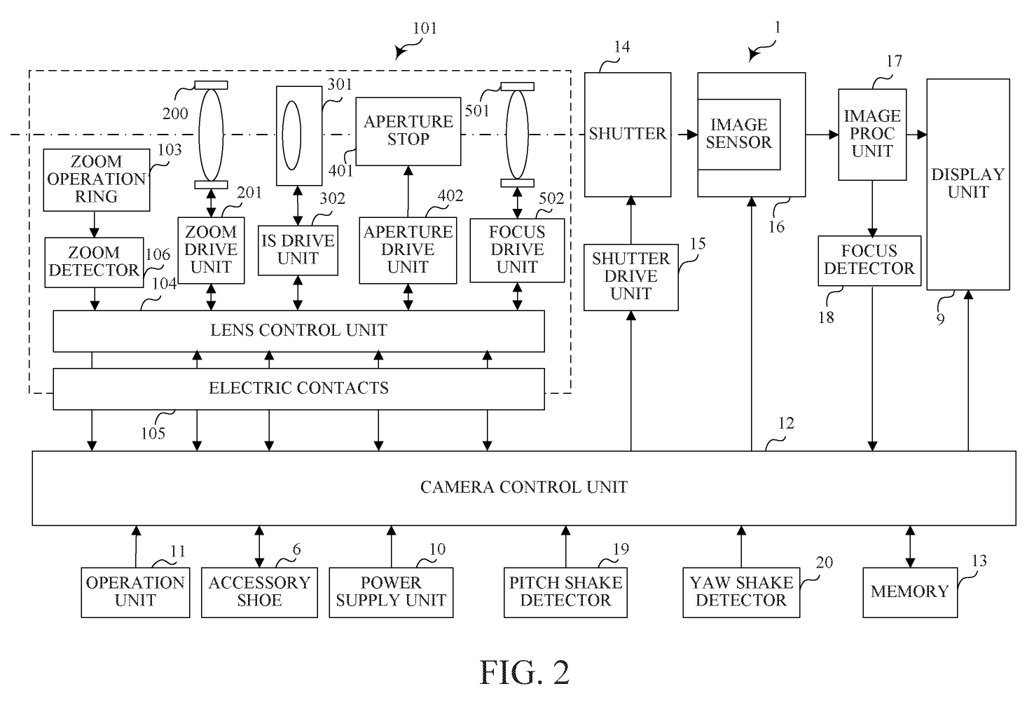

FIG. 2 is a block diagram illustrating the electrical and optical configurations of the interchangeable lens 101 and the camera body 1. The camera body 1 includes a power supply unit 10 that supplies power to the camera body 1 and the interchangeable lens 101, and an operation unit 11 including the power operation unit 3, mode dial 4, release button 5, rear operation unit 8, and touch panel function of the display unit 9. The overall system of the camera body 1 and the interchangeable lens 101 is controlled by a camera control unit 12 provided in the camera body 1 and the lens control unit 104 provided in the interchangeable lens 101 cooperating with each other. The camera control unit 12 reads and executes a computer program stored in a memory 13. At that time, the camera control unit 12 communicates with the lens control unit 104 via the communication terminals of electrical contacts 105 provided on the lens mount 102, communicating various control signals and data. The electrical contacts 105 include power terminals that supply power from the power supply unit 10 to the interchangeable lens 101.

The imaging optical system in the interchangeable lens 101 includes a zoom unit 200 that is connected to the zoom operation ring 103 and moves along the optical axis to change an angle of view, and a lens image-stabilization (IS) unit 301 that includes a shift lens (image stabilizing lens) as an image stabilizing element to reduce image blur. The lens IS unit 301 performs image stabilization by moving (shifting) the shift lens in the Z/Y axis direction orthogonal to the optical axis to reduce image blur. The imaging optical system includes an aperture (stop) unit 401 that performs light amount adjustment and a focus unit 501 that includes a focus lens that moves along the optical axis for focusing. The interchangeable lens 101 includes a zoom drive unit 201 that drives the zoom unit 200, an IS drive unit 302 that drives the lens IS unit 301, an aperture drive unit 402 that drives the aperture unit 401, and a focus drive unit 502 that drives the focus unit 501.

The camera body 1 includes the camera control unit 12, a shutter unit 14, a shutter drive unit 15, an image sensor 16, an image processing unit 17, and a focus detector 18. The shutter unit 14 controls the amount of light that is condensed by the imaging optical system in the interchangeable lens 101 and exposed to the image sensor 16. The image sensor 16 photoelectrically converts the object image formed by the imaging optical system and outputs an imaging signal. The image processing unit 17 performs various image processing on the imaging signal and then generates an image signal. The display unit 9 displays the image signal (live-view image) output from the image processing unit 17, displays the imaging parameter as described above, and plays back and displays a captured image recorded in the memory 13 or a recording medium.

The camera control unit 12 controls the driving of the aperture unit 401 and the shutter unit 14 via the aperture drive unit 402 and the shutter drive unit 15, respectively, according to the aperture value and shutter speed settings received from the operation unit 11. The camera control unit 12 also controls the driving of the focus unit 501 according to the imaging preparation operation (half-press operation) on the operation unit 11 (release button 5). For example, when autofocus operation is instructed, the focus detector 18 determines the focus state of the object image formed by the image sensor 16 based on the image signal generated by the image processing unit 17, generates a focus signal, and transmits the focus state to the camera control unit 12. In parallel, the focus drive unit 502 detects the current position of the focus unit 501 and transmits the detection signal to the camera control unit 12 via the lens control unit 104. The camera control unit 12 compares the focus state of the object image with the current position of the focus unit 501, calculates a shift amount, and transmits the focus drive amount to the lens control unit 104. Then, the lens control unit 104 drives and controls the focus unit 501 to the target position via the focus drive unit 502, correcting a focus shift of the object image.

When an AE control operation is instructed, the camera control unit 12 receives a luminance signal generated by the image processing unit 17 and performs photometric (light metering) calculation. Based on the result of this photometric calculation, the camera control unit 12 controls the driving of the aperture unit 401 in accordance with the imaging instruction operation (full press operation) on the operation unit 11 (release button 5). At the same time, the camera control unit 12 controls the driving of the shutter unit 14 via the shutter drive unit 15 and performs exposure processing by the image sensor 16.

The camera body 1 includes a pitch shake detector 19 and a yaw shake detector 20 each serving as a shake detector capable of detecting image shake such as hand shake by the user. Each of the pitch shake detector 19 and the yaw shake detector 20 uses an angular velocity sensor (vibration gyroscope) or an angular acceleration sensor to detect image shake in the pitch direction (rotation direction around the Z-axis) and the yaw direction (rotation direction around the Y-axis) and output a shake signal. The camera control unit 12 calculates the shift position of the lens IS unit 301 (shift lens) in the Y-axis direction using the shake signal from the pitch shake detector 19. Similarly, the camera control unit 12 calculates the shift position of the lens IS unit 301 in the Z-axis direction using the shake signal from the yaw shake detector 20. The camera control unit 12 then drives and controls the lens IS unit 301 to the target position according to the calculated shift position in the pitch/yaw direction, and performs an image stabilization operation to reduce image blur during exposure and live-view image display.

The interchangeable lens 101 includes a zoom operation ring 103 for changing the angle of view of the imaging optical system, and a zoom detector 106 that detects the rotation angle of the zoom operation ring 103. The zoom detector 106 uses, for example, a lever-type detection switch. The camera control unit 12 also controls the driving of the zoom unit 200 via the zoom drive unit 201 according to the detected rotation angle and the zoom speed setting value received from the operation unit 11.

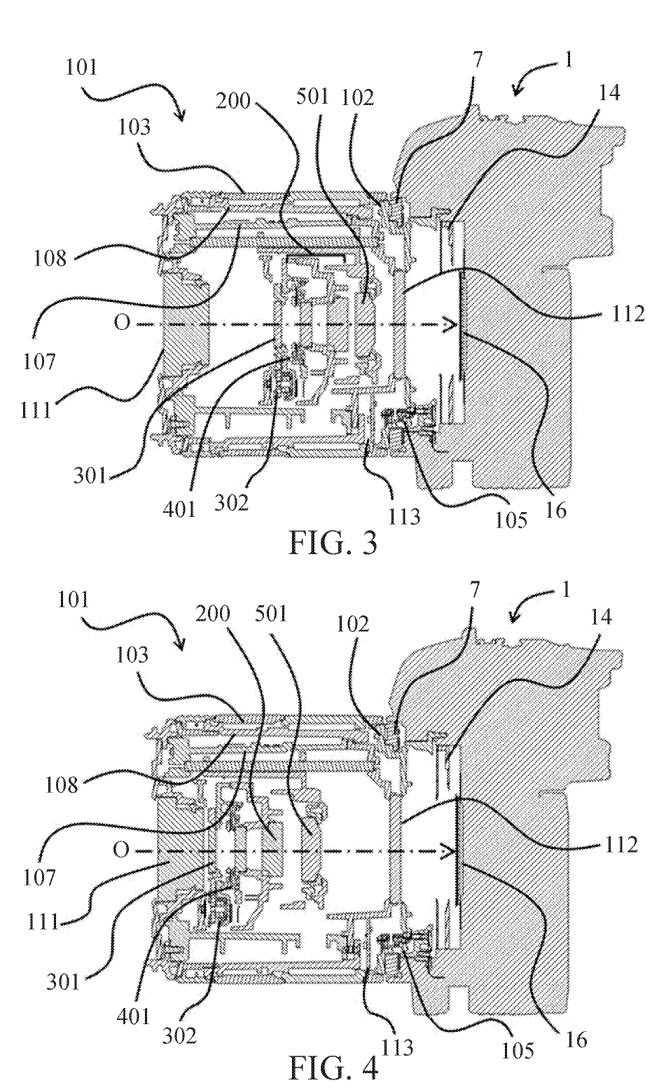

Referring to FIGS. 3 and 4, a description will be given of a positional relationship between the components of the interchangeable lens 101 and the camera body 1. FIGS. 3 and 4 are sectional views on the XY plane including the optical axis of the interchangeable lens 101 and the camera body 1 in the retracted and extended zoom states, respectively. The illustrated centerline O substantially coincides with the optical axis determined by the imaging optical system, and therefore will be treated as synonymous with the optical axis below.

This embodiment adopts a zoom configuration as an example of the imaging optical system. Each unit, moved to a predetermined optical position according to the angle of view, guides light from the object to the imaging surface of the image sensor 16. At this time, each of the lens IS unit 301, the aperture unit 401, and the focus unit 501 is disposed at predetermined positions.

The disclosure is not limited to the configuration of the lens units in this embodiment, and some of the lens units may be fixed rather than movable.

The imaging optical system includes a first fixed unit 111 and a second fixed unit 112. The first fixed unit 111 is held on a main base 107 via a plurality of rollers. The main base 107 is fixed to the lens mount 102 via a fixed cylinder 108 and holds the zoom drive unit 201 and the focus drive unit 502. The fixed cylinder 108 holds a main board 113, which houses the lens control unit 104. The second fixed unit 112 is screwed to the main base 107.

The disclosure is not limited to the configuration of the lens unit described above, and some lens units be movable rather than fixed.

### FIRST EMBODIMENT

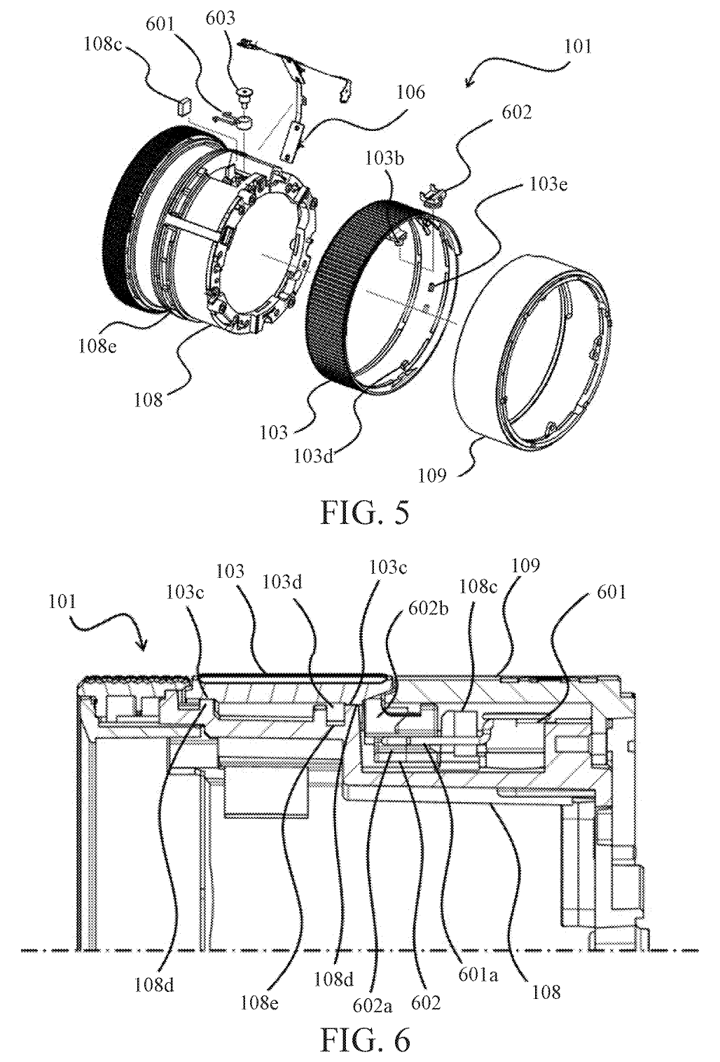

First, the structure for holding the zoom operation ring 103 to the fixing member will be described. FIG. 5 is an exploded perspective view illustrating the operation unit of the interchangeable lens 101 in a state in which some of the components are disassembled and viewed from diagonally behind. FIG. 6 is a side sectional view illustrating the configuration of the operation unit of the interchangeable lens 101 in an engagement state between the zoom operation ring 103 and the fixing member.

The zoom operation ring 103 is rotatably held relative to the fixed cylinder 108 by a zoom-operation-ring diameter engagement portion 103c and a fixed-barrel diameter engagement portion 108d, and by a bayonet claw portion 103d and a bayonet groove portion 108e. An outer ring 109 is fixed to the fixed cylinder 108 from the rear by screws. The fixed cylinder 108 and the outer ring 109 constitute a fixing member. The fixed cylinder 108 includes a zoom detector 106. The zoom detector 106 detects a predetermined angle when the zoom operation ring 103 rotates and comes into contact with a zoom detecting tab portion 103e. The fixed cylinder 108 also holds a spring member 601 via a fixing screw 603. The spring member 601 is a torsion coil spring in this embodiment, and biases the zoom operation ring 103 to a neutral position (initial position) described later via an elastic member 602 held by the zoom operation ring 103.

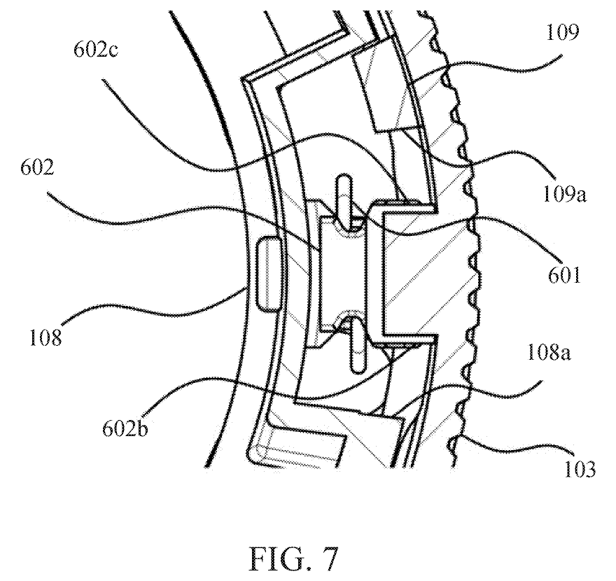

Next, the rotation limit of the zoom operation ring 103 will be described. FIG. 7 is a front sectional view of the operation unit of the interchangeable lens 101, illustrating a positional relationship between the zoom operation ring 103 and the fixing member.

The fixed cylinder 108 includes a rotation limiter 108a that limits a rotation range (moving range) of the zoom operation ring 103. When the zoom operation ring 103 rotates in one direction (first direction), the rotation limiter 108a comes into contact with a contact portion 602b of the elastic member 602. The outer ring 109 includes a rotation limiter 109a that limits the rotation range of the zoom operation ring 103. The rotation limiter 109a contacts a contact portion 602c of the elastic member 602 when the zoom operation ring 103 rotates in the other direction (second direction). The zoom operation ring 103, the fixed cylinder 108, and the outer ring 109 are made of a hard material, such as a resin material reinforced with glass fibers, while the elastic member 602 is made of a material that absorbs shocks and vibrations, such as silicone rubber. Even when the zoom operation ring 103 is rotated to an angle where the range of rotation is limited, the zoom operation ring 103 does not directly contact the fixed member but contacts the elastic member 602. This absorbs shocks and vibrations and suppresses the generation of collision noise. In addition, the feel when the user operates the zoom operation ring 103 and rotates it to the rotation limiters 108a and 109a becomes softer, improving the quality of operability.

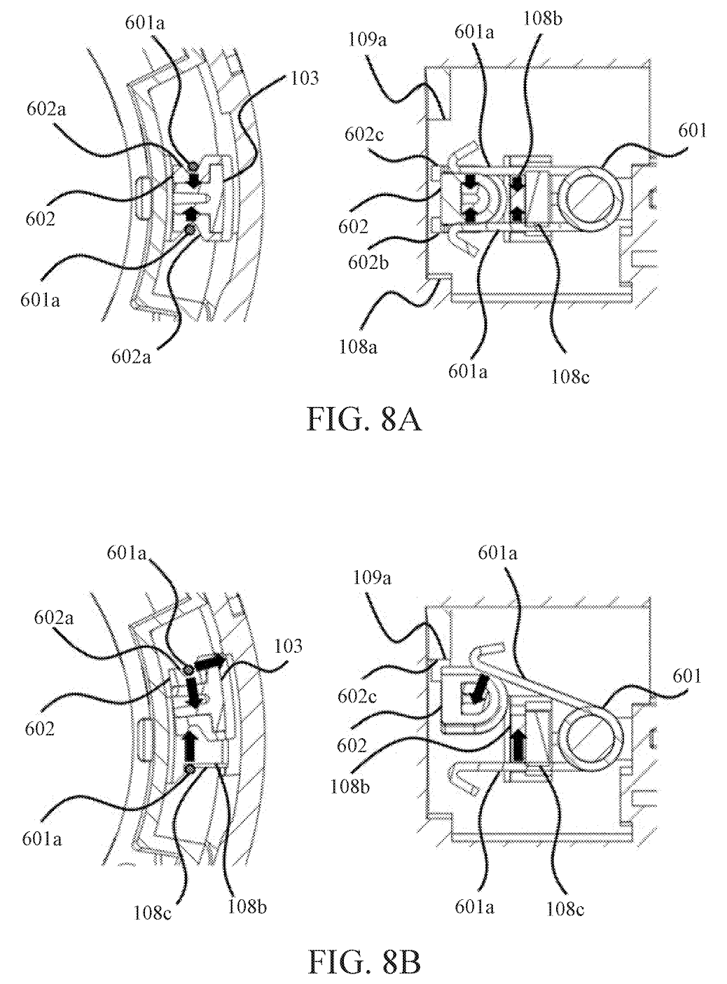

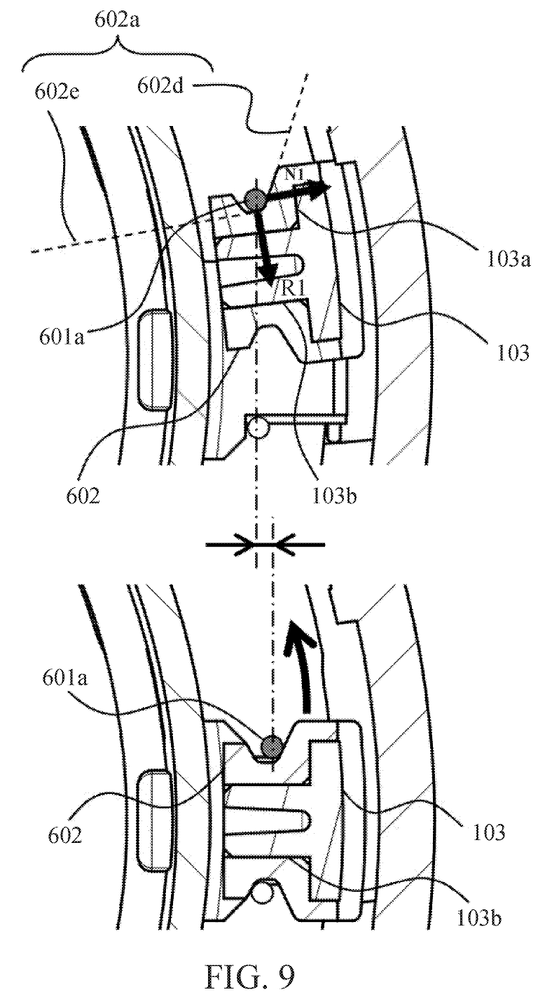

Next, the biasing force applied to the zoom operation ring 103 will be described. FIGS. 8A and 8B explain the interchangeable lens 101. FIGS. 8A and 8B are respectively front and top sectional views illustrating the shape of the spring member 601 and the direction of the biasing force when the zoom operation ring 103 is located at the neutral position and rotated in one direction. FIG. 9 is a detailed sectional view of the zoom operation ring 103, illustrating a difference between the neutral position and the position rotated in one direction, and the direction of the biasing force.

As illustrated in FIG. 8A, when the zoom operation ring 103 is located at the neutral position, an arm portion 601a of the spring member 601 is in contact with an engagement portion 602a of the elastic member 602 and a projection portion 108b of the fixed cylinder 108. The biasing force of the spring member 601 applied to the engagement portion 602a and the projection portion 108b is balanced, holding the zoom operation ring 103 at the neutral position.

In FIG. 8B, the zoom operation ring 103 is rotated in one direction, and the rotation limiter 109a and the contact portion 602c are in contact. At this time, one arm portion 601a of the spring member 601 is in contact with the engagement portion 602a, and the other arm portion 601a is in contact with the projection portion 108b, and the arm portion 601a is in an open state. Due to the biasing force of the spring member 601, the rotation limiter 109a and the contact portion 602c separate, and a torque is generated that pulls the zoom operation ring 103 back to the neutral position.

Here, referring to FIG. 9, the direction of the biasing force applied to the engagement portion 602a in FIG. 8B will be described. The engagement portion 602a includes surfaces 602d and 602e with different angles (i.e., two surfaces that are tilted relative to each other). When the zoom operation ring 103 is rotated in one direction, the biasing force R1 in the rotation direction (movement direction) is applied to the surface 602e. Since the elastic member 602 moves in an arc shape in the rotation direction, height of the elastic member 602 becomes lower than the neutral position, and one arm portion 601a of the spring member 601 is pushed down in a (rotation orthogonality) direction approximately orthogonal to the rotation direction from the neutral position (orthogonal direction), and the biasing force N1 in the orthogonal direction is applied to the surface 602d. The elastic member 602 is inserted from the inner diameter side into a projection portion (protrusion portion) 103b extending (protruding) in the (rotation orthogonality) direction orthogonal to the rotation of the zoom operation ring 103, and is held by the holding surface 103a, so it is pressed by the biasing force N1 in the rotation orthogonality direction. Thereby, the elastic member 602 is stably engaged with the spring member 601, and can suppress the vibration between the zoom operation ring 103 and the spring member 601 that occurs during operation of the zoom operation ring 103. The biasing force N1 in the rotation orthogonality direction prevents the elastic member 602 from falling off due to repeated operation.

The fixed cylinder 108 includes a buffer member 108c adjacent to the projection portion 108b and the spring member 601 in the optical axis direction. The buffer member 108c is made of an elastic material such as polyurethane, and protrudes from the projection portion 108b in the rotational direction of the zoom operation ring 103. Therefore, when the zoom operation ring 103 returns to the neutral position from the rotated state, the arm portion 601a contacts the buffer member 108c before contacting the projection portion 108b, and returns to the neutral position while compressing the buffer member 108c. This reduces the impact when the spring member 601 collides with the projection portion 108b, and since the projection portion 108b is always in contact with the arm portion 601a even in the neutral position, vibration of the spring member 601 can be suppressed. By using an elastic material that has lower hardness for the buffer member 108c than for the elastic member 602, the gap between the engagement portion 602a and the arm portion 601a is not widened by the buffer member 108c. This minimizes play at the neutral position of the zoom operation ring 103.

Thus, by placing the elastic member 602 between the zoom operation ring 103 and the rotation limiters 108a and 109a, the zoom operation ring 103 is prevented from directly contacting the fixed member, thereby suppressing collision noise. Since the spring member 601 is engaged with the elastic member 602, vibrations between the zoom operation ring 103 and the spring member 601 that occur during operation of the zoom operation ring 103 can be suppressed. Moreover, the elastic member 602 is pressed against the holding surface 103a of the zoom operation ring 103 by the biasing force N1 in the rotation orthogonality direction. Therefore, the elastic member 602 can be stably held without requiring a fall-off prevention shape or additional parts. Also, the buffer member 108c can be efficiently disposed adjacent to the spring member 601 and the projection portion 108b in the optical axis direction, suppressing collision noise and vibration between the spring member 601 and the projection portion 108b. Therefore, operating noise of the zoom operation ring 103 is reduced using a small number of parts and in a space-saving manner.

Although this embodiment discusses the holding structure of the zoom operation ring 103, the disclosure is not limited to this example, and a similar holding structure may be provided in other operation units constituting the interchangeable lens 101.

Although this embodiment discusses a rotatable zoom operation ring 103 as an example of an operation member, the disclosure is also applicable to directly movable operation members.

### SECOND EMBODIMENT

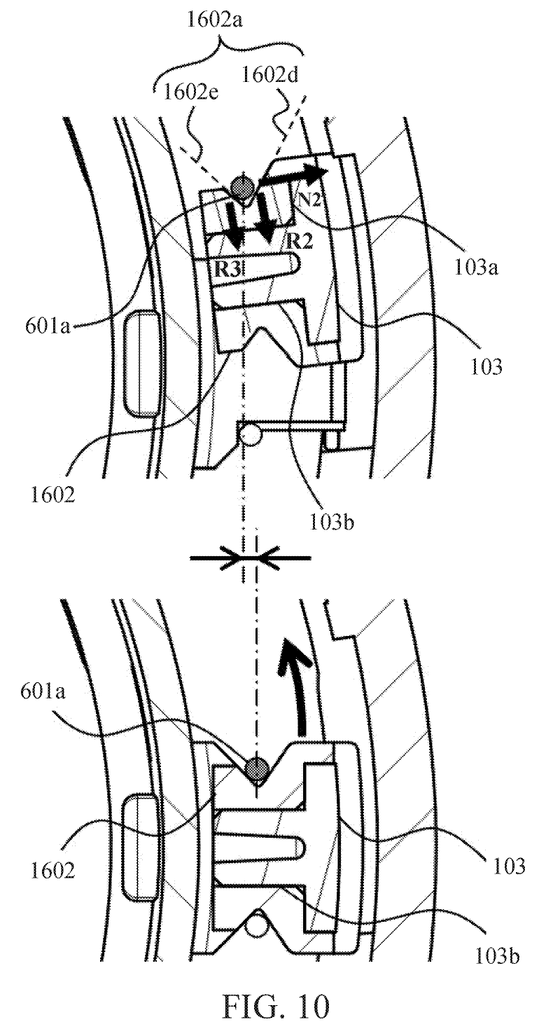

This embodiment describes the biasing force applied to the zoom operation ring, which differs from the first embodiment. FIG. 10 is a detailed sectional view of the zoom operation ring 103, illustrating a difference between the neutral position and a position rotated in one direction, and the direction of the biasing force.

An engagement portion 1602a of an elastic member 1602 has two surfaces 1602d and 1602e with different angles. When the zoom operation ring 103 is rotated in one direction, the biasing forces R2 and R3 in the rotation direction are applied to the surfaces 1602d and 1602e, respectively. Since the elastic member 1602 moves in an arc shape in the rotation direction, height of the elastic member 1602 becomes lower than the neutral position, and one arm 1601a of the spring member 1601 is pushed down in the rotation orthogonality direction from the neutral position, and the biasing force N2 in the rotation orthogonality direction is applied to the surface 1602d. The elastic member 1602 is inserted from the inner diameter side into the projection portion 103b extending in the rotation orthogonality direction of the zoom operation ring 103 and is held by the holding surface 103a, so that the elastic member 1602 is pressed by the biasing force N2 in the rotation orthogonality direction. Thereby, the stable contact between the elastic member 1602 and the spring member 1601 suppresses vibrations between the zoom operation ring 103 and the spring member 1601 that occur during operation of the zoom operation ring 103. Also, the biasing force N2 in the rotation orthogonality direction prevents the elastic member 1602 from falling off due to repeated operation.

Thus, by placing the elastic member 1602 between the zoom operation ring 103 and the rotation limiters 108a and 109a, the zoom operation ring 103 no longer directly contacts the fixed member, and collision noise can be suppressed. Since the spring member 1601 is engaged with the elastic member 1602, vibrations between the zoom operation ring 103 and the spring member 1601 that occur during operation of the zoom operation ring 103 can be suppressed. The elastic member 1602 is pressed against the holding surface 103a of the zoom operation ring 103 by the biasing force N2 in the rotation orthogonality direction. Therefore, the elastic member 1602 can be stably held without requiring a fall-off prevention shape or additional parts. In addition, the buffer member 108c can be efficiently disposed between and adjacent to the projection portion 108b and the spring member 1601 in the optical axis direction, and the collision noise and vibration between the spring member 1601 and the projection portion 108b can be suppressed. Therefore, operating noise of the zoom operation ring 103 is reduced using a small number of parts and in a space-saving manner.

This embodiment illustrates the holding structure of the zoom operation ring 103, but is not limited to this example. A similar holding structure may be provided in another operation unit constituting the interchangeable lens 101.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an optical apparatus that can reduce the operating noise of the operation member in a space-saving manner and with a small number of components.

This application claims the benefit of Japanese Patent Application No. 2025-012604, filed on January 29, 2025, which is hereby incorporated by reference herein in its entirety.

What is claimed is:

1. An optical apparatus comprising:
an operation member;
a spring member configured to bias the operation member;
a fixing member including a limiter configured to restrict a moving range of the operation member; and
an elastic member held by the operation member,
wherein the elastic member includes an engagement portion that is engaged with an arm portion of the spring member, and a contact portion that contacts the limiter, and
wherein, in a case where the contact portion is in contact with the limiter, the spring member biases the elastic member in a moving direction of the operation member and in a direction orthogonal to the moving direction.

2. The optical apparatus according to claim 1, wherein the engagement portion has two surfaces, one of which is tilted relative to the other, and
wherein one of the two surfaces is biased in the orthogonal direction by the spring member.

3. The optical apparatus according to claim 1, wherein the operation member includes a holding surface configured to hold the elastic member biased in the orthogonal direction.

4. The optical apparatus according to claim 1, wherein the operation member includes a projection portion into which the elastic member is inserted, and the protrusion portion protrudes from the engagement portion in the orthogonal direction.

5. The optical apparatus according to claim 1, wherein the contact portion includes a first contact portion that contacts the limiter in a case where the operation member moves in a first direction, and a second contact portion that contacts the limiter in a case where the operation member moves in a second direction different from the first direction.

6. The optical apparatus according to claim 1, wherein the fixing member includes a projection portion configured to engage an arm portion of the spring member that is not engaged by the engagement portion, in a case where the operation member moves.

7. The optical apparatus according to claim 6, wherein the fixing member includes a buffer member that protrudes from the projection portion in the moving direction, and
wherein a hardness of the fixing member is less than a hardness of the elastic member.

8. The optical apparatus according to claim 1, wherein the spring member is held by the fixing member.

9. The optical apparatus according to claim 1, wherein the spring member is a torsion coil spring.

10. The optical apparatus according to claim 1, wherein the fixing member includes a first member configured to restrict a moving range of the operation member in a first direction, and a second member configured to restrict a moving range of the operation member in a second direction different from the first direction.

11. The optical apparatus according to claim 1, wherein the operation member is rotatable from an initial position in a first direction or in a second direction.
